(19) United States
(12) Patent Application Publication
(10) Pub. No.: US 2004/0222257 A1
(43) Pub. Date: Nov. 11, 2004

(54) Carrying strap and manufacture thereof

(76) Inventors: Stanley M. Erdreich JR., Birmingham, AL (US); Merritt L. Pizitz, Birmingham, AL (US)

Correspondence Address: EDMOND S. MIKSCH, 3825 GREEN VALLEY DRIVE, PITTSBURGH, PA, 15235, US

(21) Appl. No.: 10/429,361

(22) Filed: May 5, 2003

(51) Int. Cl. A01K 1/00; A45F 3/02

(52) U.S. Cl. 224/103; 224/609

(57) ABSTRACT

A carrying strap for game birds or animals includes a strip of thin, flexible material for passing over a person's shoulder. At each end of the strip of thin, flexible material is a cord having both ends secured to that end of the strip. The length of each cord is sufficient for forming a lark's head knot for holding the neck or extremity of one or more game birds or animals.

### FIELD OF THE INVENTION

The present invention pertains to carrying straps and, more particularly, it pertains to carrying straps for hunters.

### BACKGROUND OF THE INVENTION

A number of background patents teach devices for carrying small game or birds taken by hunters. U.S. Pat. No. 825,753, entitled “Carrier for Game” has a pair of carrier cords tied together at their ends and attached to a shoulder strap, a belt or a handle. A button slides along the pair of cords under friction so the pair of cords can be used to form an adjustable loop. A foot, wing or head of the bird or animal to be carried is placed between the cords and the button is slid along the cords to reduce the size of the loop and secure the bird or animal. The buttons, preferably, are made of leather.

U.S. Design Pat. No. D 347,117, entitled “Releasable Small Game Carrier” employs cords and a button having a particular appearance.

U.S. Pat. No. 2,819,923, entitled “Suspension Sling” is for suspending game or other carcasses above the ground. It employs a thin strand of flexible material such as steel wire cable having a permanent loop and an adjustable loop. The permanent loop is for placing over a suitable support such as a tree branch and the adjustable loop is for securing the legs or other portion of the carcass. The adjustable loop includes a block which is slid along the strand of material to act as a slip noose in order to secure the carcass.

U.S. Pat. No. 4,529,240, entitled “Carrying Device” is a cable device for dragging or skinning animals, or for attaching articles to a horse saddle. It has a sleeve for sliding on the cable, thus providing a slip noose.

U.S. Pat. No. 5,277,347, entitled “Small Game Holder” is for suspending small game animals or birds from a hunter's belt. It includes a pair of heavy strings with a plurality of cord locks to secure a plurality of animals or birds.

U.S. Pat. No. 5,806,732, entitled “Call lanyard” includes a loop for passing around a hunter's neck. A plurality of call holder cords depend from the loop and are for attachment of a plurality of hunting calls.

U.S. Pat. No. 6,089,632 entitled “Adjustable Game Drag Assembly” includes a slip noose for securing the neck or an appendage of a slain game animal. It also has a plurality of hand hold members attachable to the slip noose so that one or more persons can drag the animal.

U.S. Pat. No. 6,443,338 entitled “Bottled Drink Carrier Apparatus” includes a strap for passing around a person's neck. It also has a loop with a slide lock for securing the neck of a bottle containing a drink product.

Other background apparatus for carrying slain birds or game includes bags for containing the birds or game animals.

The inventions cited above generally require some complicated manufacturing steps such as tying knots and providing various sliders or locks used to create one or more slip nooses. Furthermore, the inventions cited above do not teach the use of materials or configurations which are easy to clean.

### INTRODUCTION TO THE INVENTION

The present invention is a carrying device for hunters. It includes a shoulder strap and two cords attached to the shoulder strap, the cords being for securing small game or birds.

One objective of the present invention is to support the weight of game animals or birds from the shoulder of a hunter.

Another objective of the present invention is to provide a convenient arrangement for carrying a plurality of game animals or birds.

An additional objective of the present invention is to provide an arrangement for carrying game animals or birds that leaves the hunter's hands free.

Yet a further objective of the present invention is to provide an arrangement for carrying game animals or birds that is easy to clean.

Yet another objective of the present invention is to provide a carrying strap for game birds or animals that is easy to detach from the game birds or animals.

Another objective of the present invention is to provide a carrying arrangement for game or birds that is economical to manufacture.

Yet another objective of the present invention is to provide an economical method of manufacturing a carrying strap for hunters.

In addition to the various objectives and advantages of the present invention which have been generally described above, there will be various other objectives and advantages of the invention that will become more readily apparent to those persons who are skilled in the relevant art from the following more detailed description of the invention, particularly, when the detailed description is taken in conjunction with the attached drawing figures and with the appended claims.

### SUMMARY OF THE INVENTION

In one aspect, the present invention is a carrying strap for carrying at least one game bird or animal. It includes a strip of thin, flexible material, here described as including a first end portion, a median portion, and a second end portion. The length of the median portion is sufficient to pass over a person's shoulder. The carrying strap also includes a first cord, here described as including a first cord first end portion, a first cord median portion, and a first cord second end portion, both the first cord first end portion and the first cord second end portion being attached to the first end portion of the strip of thin, flexible material. The length of the median portion of the first cord is sufficient to form a first lark's head knot on the first cord. The first lark's head knot is for holding the neck or one or more extremity of the game bird(s) or animal(s). It also includes a second cord, here described as including a second cord first end portion, a second cord median portion, and a second cord second end portion, both the second cord first end portion and the second cord second end portion being attached to the second end portion of the strip of thin, flexible material. The length of the median portion of the second cord is sufficient to form a second lark's head knot on the second cord. The second lark's head knot is for holding a neck or extremity of the game bird(s) or animal(s).

In another aspect, the present invention is a packaged carrying strap product for hunters. The packaged carrying strap product includes a carrying strap for carrying at least one game bird or animal. The carrying strap includes a strip of thin, flexible material here described as including a first end portion, a median portion, and a second end portion. The length of the median portion is sufficient to pass over a person's shoulder. The carrying strap also includes a first cord, here described as including a first cord first end portion, a first cord median portion, and a first cord second end portion, both the first cord first end portion and the first cord second end portion being attached to the first end portion of the strip of thin, flexible material. The length of the median portion of the first cord is sufficient to form a first lark's head knot on the first cord. The first lark's head knot is for holding the neck or at least one extremity of the game bird(s) or animal(s). The carrying strap also includes a second cord, here described as including a second cord first end portion, a second cord median portion, and a second cord second end portion. Both the second cord first end portion and the second cord second end portion are attached to the second end portion of the strip of thin, flexible material. The length of the median portion of the second cord is sufficient to form a second lark's head knot on the second cord. The second lark's head knot is for holding the neck or at least one extremity of the game bird(s) or animal(s). The packaged carrying strap product further includes instructions for forming a lark's head knot to hold at least one game bird or animal and at least one illustration of the carrying strap with one or both of the cords formed as a lark's head knot.

In another aspect, the present invention is a method of making a carrying strap for game birds or animals. The method includes obtaining a strip of thin, flexible material, the length of a median portion of the strip of thin, flexible material being suitable for passing over a person's shoulder. The method also includes obtaining a first cord and a second cord, a length of a median portion of each cord being sufficient to form a lark's head knot for holding a neck or extremity of at least one game bird or animal. The method also includes attaching a first end portion and a second end portion of the first cord to a first end portion of the strip of thin, flexible material, and attaching a first end portion and a second end portion of the second cord to a second end portion of the strip of thin, flexible material.

### DESCRIPTION OF THE DRAWINGS

FIG. 1 is an illustration of a carrying strap according to the present invention.

FIG. 2 is a plan view of a strip of thin, flexible material comprised in the present invention.

FIG. 3 is a view along an edge of the strip of thin, flexible material.

FIG. 4 is an illustration of a first cord comprised in the present invention.

FIG. 5 is an illustration of a second cord comprised in the present invention.

FIG. 6 is a plan view illustrating attachment of the first cord to the strip of thin, flexible material.

FIG. 7 is a sectional view along line 7-7 in FIG. 6.

FIG. 8 is a plan view illustrating attachment of the second cord to the strip of thin, flexible material.

FIG. 9 is a sectional view along line 9-9 in FIG. 8.

FIG. 10 is an illustration of a first lark's head knot formed on the first cord for carrying one or more game birds or animals.

FIG. 11 illustrates the present invention employed to carry a plurality of game birds.

FIG. 12 illustrates the present invention employed to carry a plurality of game animals.

FIG. 13 is a schematic illustration of a packaged carrying strap product including an illustration of a lark's head knot.

### NOMENCLATURE

10 Carrying strap

12 Game bird

13 Neck

14 Animal

15 Extremity

17 Person

18 Shoulder

20 Strip of thin, flexible material

22 First end portion of strip

23 First covered portion of strip

24 First covering portion of strip

26 Median portion of strip

28 Second end portion of strip

29 Second covered portion of strip

30 Second covering portion of strip

32 Length of median portion of strip

33 Width of strip

34 Thickness of strip

35 Length of strip

40 First cord

41 First cord first end portion

42 First cord median portion

43 First cord second end portion

44 Length of median portion of first cord

45 First lark's head knot

46 First stitching

47 Diameter of first cord

48 Length of first cord

49 Additional first stitching

50 Second cord

51 Second cord first end portion

52 Second cord median portion

53 Second cord second end portion

54 Length of median portion of second cord

55 Second lark's head knot

56 Second stitching

57 Diameter of second cord

58 Length of second cord

59 Additional second stitching

60 Carrying strap product

61 Instructions

62 Packaging means

64 Illustration

75 Loop formed by first lark's head knot

### DETAILED DESCRIPTION OF THE INVENTION

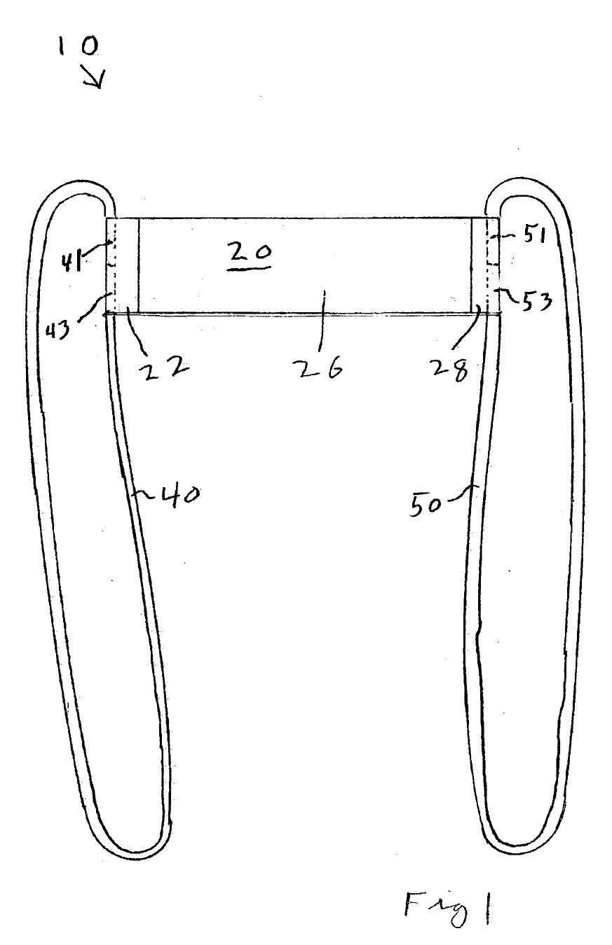

Attention is directed to FIG. 1 that illustrates a carrying strap, generally designated 10, according to a presently preferred embodiment of the present invention. Carrying strap 10 includes a strip of thin, flexible material 20 that is for passing over a person's shoulder. Carrying strap 10 further includes a first cord 40 having a first cord first end portion 41 and a first cord second end portion 43. First cord first end portion 41 and first cord second end portion 43 are attached to first end portion 22 of the strip of thin, flexible material 20.

Carrying strap 10 further includes a second cord 50 having a second cord first end portion 51 and a second cord second end portion 53. Second cord first end portion 51 and second cord second end portion 53 are attached to second end portion 28 of the strip of thin, flexible material 20.

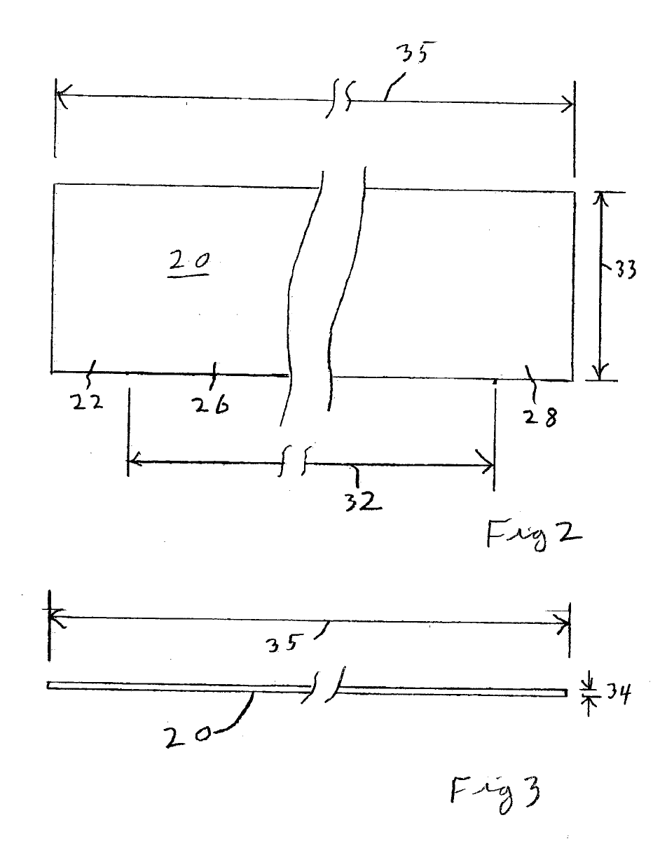

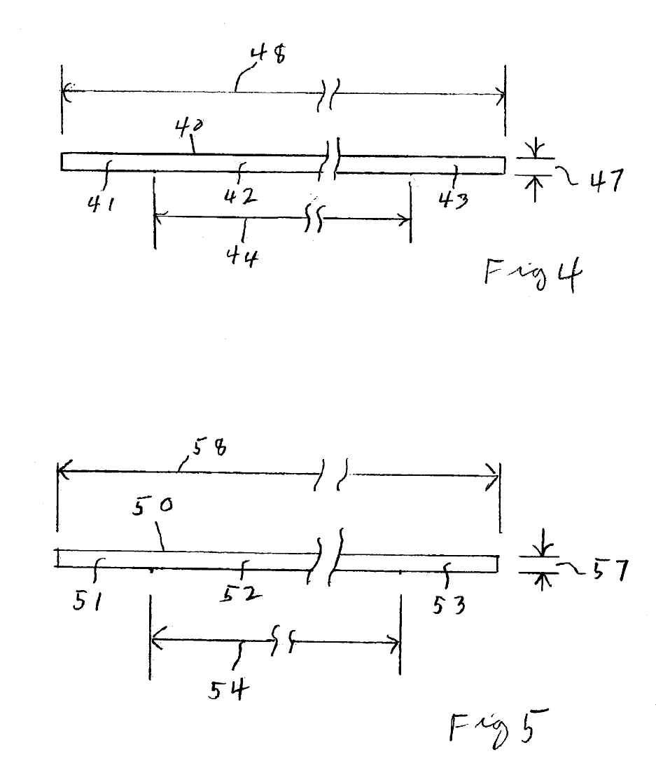

FIGS. 2 and 3 show plan and edgewise views, respectively, of the strip of thin, flexible material 20 prior to its incorporation into carrying strap 10. The strip of thin, flexible material 20 has a median portion 26 having a length 32 sufficient for passing over a person's shoulder. In the presently preferred embodiment of the invention, the length 32 of median portion 26 is about 18 centimeters. The strip 20 has a width 33 appropriate for lying on a person's shoulder without folding or creasing. In the presently preferred embodiment width 33 is about 5 centimeters. The strip 20 has a thickness 34 that is sufficient to prevent strip 20 from folding or creasing. In the presently preferred embodiment, thickness 34 is about 0.2 centimeters. The strip of thin, flexible material 20, including first end portion 22, median portion 26 and second end portion 28, has length 35. Length 35 is sufficient to provide the required length for median portion 32, as well as first end portion 22 and second end portion 28. The material employed for strip 20, preferably, is easy to clean.

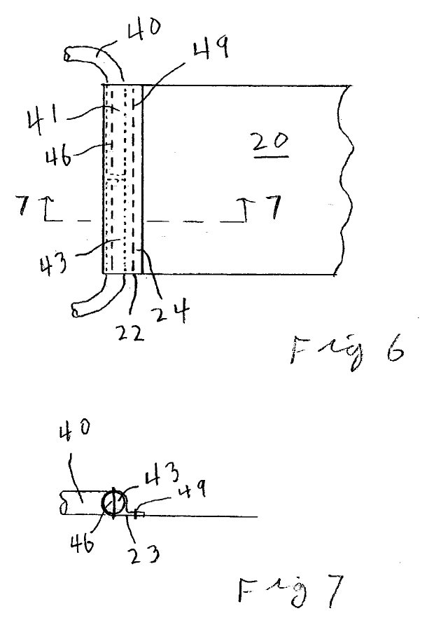

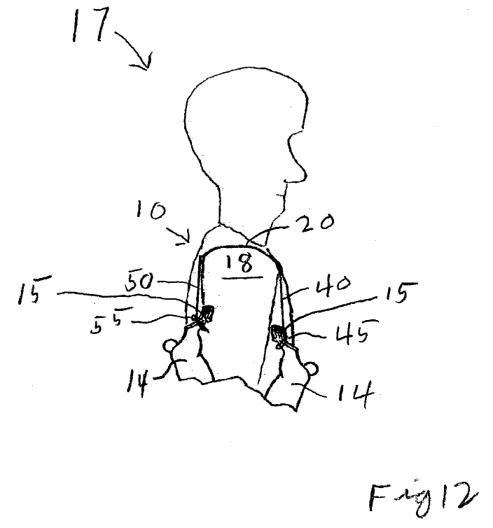

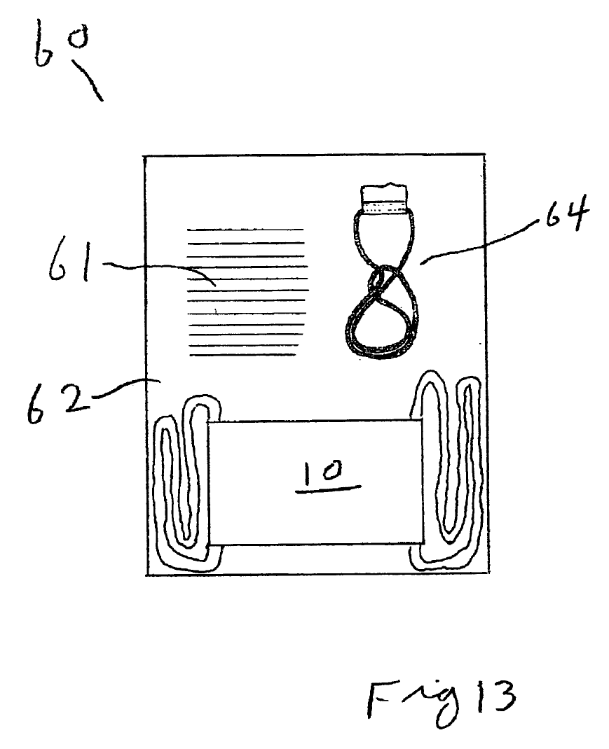

FIGS. 4 and 5 show first cord 40 and second cord 50, respectively, prior to their incorporation into carrying strap 10. First cord 40 has a first cord first end portion 41, a first cord median portion 42, a first cord second end portion 43, and a length 48. The length 44 of median portion 42 is sufficient to form a first lark's head knot (best seen in FIG. 10) for holding a neck or extremity of a game bird or animal, as shown in FIGS. 11 and 12.

In the presently preferred embodiment, the length 48 of first cord 40 is about 80 centimeters, and the diameter 47 of first cord 40 is about 0.4 cm. Preferably, first cord 40 comprises woven synthetic fibers. Nylon cord is presently most preferred for first cord 40. Such a cord is very flexible, even at a diameter of 0.4 cm. and is easy to clean.

Second cord 50 has a second cord first end portion 51, a second cord median portion 52, a second cord second end portion 53, and a length 58. The length 54 of median portion 52 is sufficient to form a second lark's head knot similar to the first lark's head knot shown in FIG. 10 for holding a neck or extremity of a game bird or animal, as shown in FIGS. 11 and 12.

In the presently preferred embodiment, the length 58 of second cord 50 is about 80 centimeters, and the diameter 57 of second cord 50 is about 0.4 cm. Preferably, second cord 50 comprises woven synthetic fibers. Nylon cord is presently most preferred for second cord 50. It is presently preferred that second cord 50 be substantially identical to first cord 40.

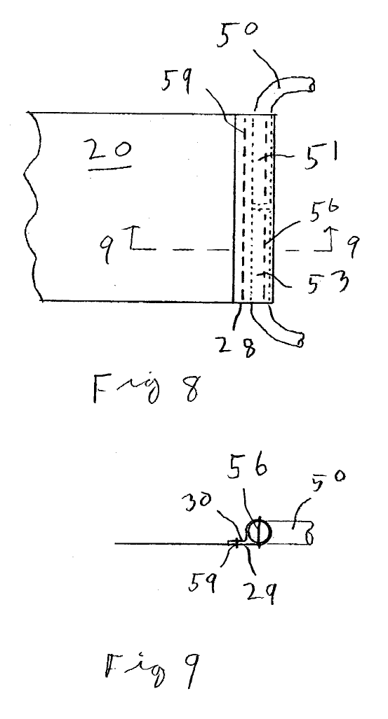

FIGS. 6 and 7 illustrate the attachment of first cord 40 to the first end portion 22 of the strip of thin, flexible material 20. FIG. 7 is a sectional view along line 7-7 in FIG. 6. First end portion 41 and second end portion 43 of first cord 40 are enclosed between first covering portion 24 of the strip of thin, flexible material 20 and first covered portion 23 of the strip of thin, flexible material 20. The first covering portion 24 and the first covered portion 23 of the strip of thin, flexible material 20 are, preferably, comprised in first end portion 22 of the strip of thin, flexible material 20. The first cord first end portion 41 and the first cord second end portion 43 are, preferably, secured by first stitching 46. First stitching 46 passes through first covering portion 24, first cord first end portion 41, first cord second end portion 43 and first covered portion 23 of the strip of thin, flexible material 20. Preferably, additional first stitching 49 attaches first covering portion 24 of strip 20 to first covered portion 23 of strip 20. Preferably, the first cord first end portion 41 and the first cord second end portion 43 are orthogonal to the length 35 of the strip of thin, flexible material 20.

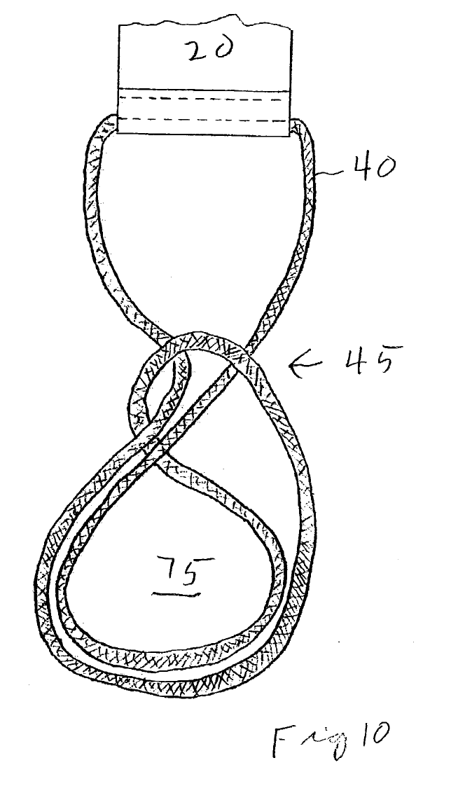

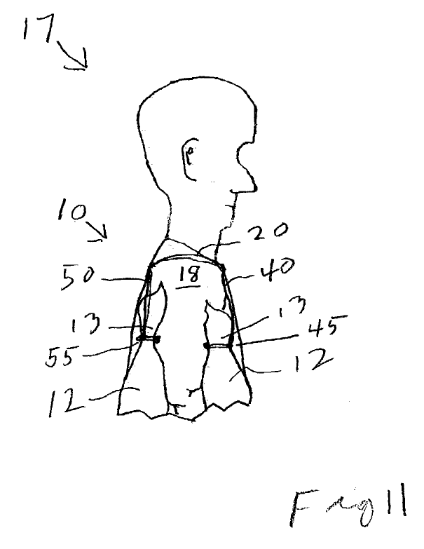

FIGS. 8 and 9 illustrate the attachment of second cord 50 to the second end portion 28 of the strip of thin, flexible material 20. FIG. 9 is a sectional view along line 9-9 in FIG. 8. First end portion 51 and second end portion 53 of second cord 50 are enclosed between second covering portion 30 of the strip of thin, flexible material 20 and second covered portion 29 of the strip of thin, flexible material 20. The second covering portion 30 and the second covered portion 29 of the strip of thin, flexible material 20 are, preferably, comprised in second end portion 28 of the strip of thin, flexible material 20.

The second cord first end portion 51 and the second cord second end portion 53 are, preferably, secured by second stitching 56. Second stitching 56 passes through second covering portion 30, second cord first end portion 51, second cord second end portion 53 and second covered portion 29 of the strip of thin, flexible material 20. Preferably, additional second stitching 59 attaches second covering portion 30 of strip 20 to second covered portion 29 of strip 20. Preferably, the second cord first end portion 51 and the second cord second end portion 53 are orthogonal to the length 35 of the strip of thin, flexible material 20.

Accordingly, to produce the invention, a strip of thin, flexible material 20 having dimensions as discussed above is obtained, as well as first cord 40 and second cord 50, likewise having dimensions as discussed above. First cord 40 and second cord 50 are then attached to the strip of thin, flexible material 20, as discussed above and illustrated in FIGS. 6, 7, 8 and 9.

Attention is now directed to FIG. 10 that illustrates the first lark's head knot 45, which the user of the invention forms in first cord 40. First lark's head knot 45 creates a loop 75 for holding a neck or extremity of one or more game birds or animals.

FIG. 11 illustrates a person 17 employing the invention to carry a plurality of game birds 12. The strip of thin flexible material 20 of carrying strap 10 rests on shoulder 18 of person 17. A first lark's head knot 45 is formed in first cord 40 to hold neck 13 of one or more game birds 12. Likewise, a second lark's head knot 55 is formed in second cord 50 to hold neck 13 of game bird 12. The second lark's head knot is formed in the same manner as first lark's head knot 45, illustrated in FIG. 10. Either the first lark's head knot 45 or the second lark's head knot 55 may hold a plurality of game birds (not shown).

Likewise, FIG. 12 illustrates the person 17 employing the invention to carry a plurality of game animals 14. The strip of thin, flexible material 20 of carrying strap 10 rests on shoulder 18 of person 17. A first lark's head knot 45 is formed in first cord 40 to hold extremities 15 of game animal 14. Likewise, a second lark's head knot 55 is formed in second cord 50 to hold the extremities 15 of game animal 14. Either the first lark's head knot 45 or the second lark's head knot 55 may hold a plurality of game animals (not shown).

If a single game bird 12 or animal 14 is to be carried, both the first lark's head knot 45 and the second lark's head knot 55 may be placed on the single game bird 12 or animal 14.

Inasmuch as the user of the invention needs to be advised of the use of the first lark's head knot 45 and the second lark's head knot 55, the invention may be sold as a carrying strap product 60 including carrying strap 10 in packaging means 62. Packaging means 62 may, for example, may be a display card. Carrying strap product 60 includes instructions 61 and illustration 64 for forming the lark's head knots 45 and 55.

While a preferred embodiment of the present invention has been described above, in accordance with the patent statutes, it should be recognized that many variations and adaptations of the invention are possible without departing from the scope and spirit of the invention as expressed in the following claims.

We claim:

1. A carrying strap for carrying at least one game bird or animal, said carrying strap comprising:
a strip of thin, flexible material, here described as comprising a first end portion, a median portion, and a second end portion, a length of said median portion being sufficient to pass over a person's shoulder;
a first cord, here described as comprising a first cord first end portion, a first cord median portion, and a first cord second end portion, both said first cord first end portion and said first cord second end portion being attached to said first end portion of said strip of thin, flexible material, a length of said median portion of said first cord being sufficient to form a first lark's head knot on said first cord, said first lark's head knot for holding a neck or at least one extremity of at least one of said at least one game bird or animal; and
a second cord, here described as comprising a second cord first end portion, a second cord median portion, and a second cord second end portion, both said second cord first end portion and said second cord second end portion being attached to said second end portion of said strip of thin, flexible material, a length of said median portion of said second cord being sufficient to form a second lark's head knot on said second cord, said second lark's head knot for holding a neck or at least one extremity of at least one of said at least one game bird or animal.

2. A carrying strap, according to claim 1, wherein said first end portion of said strip of thin, flexible material comprises a first covered portion and a first covering portion, said first covering portion being wrapped around said first cord first end portion and said first cord second end portion to enclose said first cord first end portion and said first cord second end portion.

3. A carrying strap, according to claim 2, wherein said first cord first end portion and said first cord second end portion are attached to said first end portion of said strip of thin, flexible material by first stitching, said first stitching passing through said first covering portion, said first cord first end portion, said first cord second end portion, and said first covered portion of said strip of thin, flexible material.

4. A carrying strap, according to claim 3, wherein said first cord first end portion and said first cord second end portion are orthogonal to said strip of thin, flexible material.

5. A carrying strap, according to claim 1, wherein said second end portion of said strip of thin, flexible material comprises a second covered portion and a second covering portion, said second covering portion being wrapped around said second cord first end portion and said second cord second end portion to enclose said second cord first end portion and said second cord second end portion.

6. A carrying strap, according to claim 5, wherein said second cord first end portion and said second cord second end portion are attached to said second end portion of said strip of thin, flexible material by second stitching, said second stitching passing through said second covering portion, said second cord first end portion, said second cord second end portion, and said second covered portion of said strip of thin, flexible material.

7. A carrying strap, according to claim 6, wherein said second cord first end portion and said second cord second end portion are orthogonal to said strip of thin, flexible material.

8. A carrying strap, according to claim 1, wherein said strip of thin, flexible material has a width of about 5 centimeters.

9. A carrying strap, according to claim 1, wherein said median portion of said strip of thin, flexible material has a length of at least about 18 centimeters.

10. A carrying strap, according to claim 1, wherein said strip of thin, flexible material is sufficiently thick that it resists creasing or folding over said person's shoulder.

11. A carrying strap, according to claim 1, wherein said strip of thin, flexible material has a thickness of about 0.2 cm.

12. A carrying strap, according to claim 1, wherein at least one of said first cord and said second cord comprises a synthetic fibrous material.

13. A carrying strap, according to claim 1, wherein at least one of said first cord and said second cord comprises woven nylon cords.

14. A carrying strap, according to claim 1, wherein at least one of said first cord and said second cord has a diameter of about 0.4 cm.

15. A carrying strap, according to claim 1, wherein at least one of said first cord and said second cord has a length of about 80 centimeters.

16. A packaged carrying strap product for hunters, said packaged carrying strap product comprising:
a carrying strap for carrying at least one game bird or animal, said carrying strap comprising:
a strip of thin, flexible material here described as comprising a first end portion, a median portion, and a second end portion, a length of said median portion being sufficient to pass over a person's shoulder;
a first cord, here described as comprising a first cord first end portion, a first cord median portion, and a first cord second end portion, both said first cord first end portion and said first cord second end portion being attached to said first end portion of said strip of thin, flexible material, a length of said median portion of said first cord being sufficient to form a first lark's head knot on said first cord, said first lark's head knot for holding a neck or at least one extremity of at least one of said at least one game bird or animal; and
a second cord, here described as comprising a second cord first end portion, a second cord median portion, and a second cord second end portion, both said second cord first end portion and said second cord second end portion being attached to said second end portion of said strip of thin, flexible material, a length of said median portion of said second cord being sufficient to form a second lark's head knot on said second cord, said second lark's head knot for holding a neck or at least one extremity of at least one of said at least one game bird or animal;
Instructions for forming at least one of said first cord and said second cord as a lark's head knot to hold a neck or at least one extremity of said at least one game bird or animal; and
at least one illustration of said carrying strap with at least one of said first cord and said second cord formed as at least one of said first and said second lark's head knot.

17. A method of making a carrying strap for game birds or animals, said method comprising the following steps:
obtaining a strip of thin, flexible material, a length of a median portion of said strip of thin, flexible material being suitable for passing over a person's shoulder;
obtaining a first cord, a length of a median portion of said first cord being sufficient to form a first lark's head knot for holding a neck or extremity of at least one of said at least one game bird or animal;
attaching a first end portion and a second end portion of said first cord to a first end portion of said strip of thin, flexible material;
obtaining a second cord, a length of a median portion of said second cord being sufficient to form a second lark's head knot for holding a neck or extremity of at least one of said at least one game bird or animal; and
attaching a first end portion and a second end portion of said second cord to a second end portion of said strip of thin, flexible material.

18. A method, according to claim 17, wherein said step of attaching said first end portion and said second end portion of said first cord to a first end portion of said strip of thin, flexible material comprises the following steps:
wrapping a first covering portion of said strip of thin flexible material around said first end portion and said second end portion of said first cord to enclose said first cord first end portion and said first cord second end portion; and
stitching through said first covering portion of said strip of thin, flexible material, through said first end portion of said first cord, through said second end portion of said first cord, and through said first covered portion of said strip of thin, flexible material.

19. A method, according to claim 18, wherein said step of attaching said first end portion and said second end portion of said second cord to a second end portion of said strip of thin, flexible material comprises the following steps:
wrapping a second covering portion of said strip of thin flexible material around said first end portion and said second end portion of said second cord to enclose said second cord first end portion and said first cord second end portion; and
stitching through said second covering portion of said strip of thin, flexible material, through said first end portion of said second cord, through said second end portion of said second cord, and through said second covered portion of said strip of thin, flexible material.
